(19) United States
(12) Patent Application Publication
(10) Pub. No.: US 2006/0162161 A1
(43) Pub. Date: Jul. 27, 2006

(54) Method and apparatus for continuous parallel conveyance of heat pipe

(76) Inventor: Hul-Chun Hsu, Taichung City (TW)

Correspondence Address: HDSL, 4331 STEVENS BATTLE LANE, FAIRFAX, VA, 22033, US

(21) Appl. No.: 11/043,129

(22) Filed: Jan. 27, 2005

(51) Int. Cl. B23P 15/26; B23P 6/00

(52) U.S. Cl. 29/890.032; 29/726

(57) ABSTRACT

A method and an apparatus for continuous conveyance of heat pipes, by which the heat pipes are continuous disposed in parallel an abutting each other, such that the subsequently fed-in heat pipes can push the previously fed-in heat pipes forward, allowing the processes such as gas removal, press sealing of the pipe openings and other process such as soldering to be performed.

### BACKGROUND OF THE INVENTION

The present invention relates in general to a method and an apparatus for continuous parallel conveyance of heat pipes, and more particularly, to a method that provides continuous and parallel heat pipes, and performs gas removal, lamination, soldering by feeding process of the heat pipes.

The characteristics of high thermal transfer capability, high heat transfer speed, high thermal, active-device-less, simple structure, and versatility usage, heat pipes have been used in electronic products to transfer massive amount of heat without consuming electricity. The conventional heat pipe includes a wick structure which is in the form of mesh that has capillary function to assist the flow of working fluid therein.

In the fabrication of heat pipe, removal of non-condense gas and pipe sealing have to be performed by the cleaning, annealing and fluid filling processes. Along the above processes, a mechanical arm is used to position or convey the heat pipes, this often cause damage of the pipe body. In addition, the conveyance performed by the mechanical arm is very time consuming.

### BRIEF SUMMARY OF THE INVENTION

A method and an apparatus for continuous parallel conveyance of heat pipes are provided. By arranging the pipe material continuous and parallel with each other, the heat pipes are abutting each other. Therefore, when the subsequent pipes are fed in, the previously pipes are pushed forward to achieve gas removal, opening sealing and soldering effect. Therefore, the heat pipes can be fabricated continuously to enhance the production performance.

Accordingly, the method for continuously conveying and process heat pipes arranged in parallel to each other of the present invention includes the following steps: a) feeding a plurality of heat pipes each comprising a wick structure and a working fluid into a process platform; b) inputting thermal energy to the heat pipes moving in the process platform; c) pressing a sealing end of each heat pipe by protruding a pressing mechanism into the process platform; and d) soldering the pressed sealing end of each heat pipe by protruding a soldering point into the process platform.

Furthermore, the apparatus for continuously conveying heat pipes arranged parallel to each other of the present invention includes a process platefore, a heating element, a pressing mechanism and a soldering mechanism. The process platform having a feeding end and a dispensing end, wherein the heat pipes are fed into the process platform from the feeding end. The heating element for heating the heat pipes fed in the process platform. The pressing mechanism having an pair of pressing molds protruding into the process platform for pressing a sealing end of each of the heat pipes. The soldering mechanism having a soldering point protruding into the process platform for soldering the pressed sealing ends of the heat pipes.

### BRIEF DESCRIPTION OF THE DRAWINGS

The above objects and advantages of the present invention will be become more apparent by describing in detail exemplary embodiments thereof with reference to the attached drawings in which:

FIG. 1 is a side view showing the apparatus for providing continuous and parallel conveyance of heat pipes;

FIG. 2 is a top view of the apparatus as shown in FIG. 1;

FIG. 3 shows a pressing process;

FIG. 4 shows another pressing process;

FIG. 5 shows a soldering process;

FIG. 6 shows another soldering process;

FIG. 7 shows a pipe dispense process; and

FIG. 8 is a side view showing another embodiment of an apparatus for providing continuous and parallel conveyance of heat pipes;

FIG. 9 shows the rear view of the apparatus of FIG. 8; and

FIG. 10 is a rear view showing another embodiment of an apparatus for providing continuous and parallel conveyance of heat pipes.

### DETAILED DESCRIPTION OF THE INVENTION

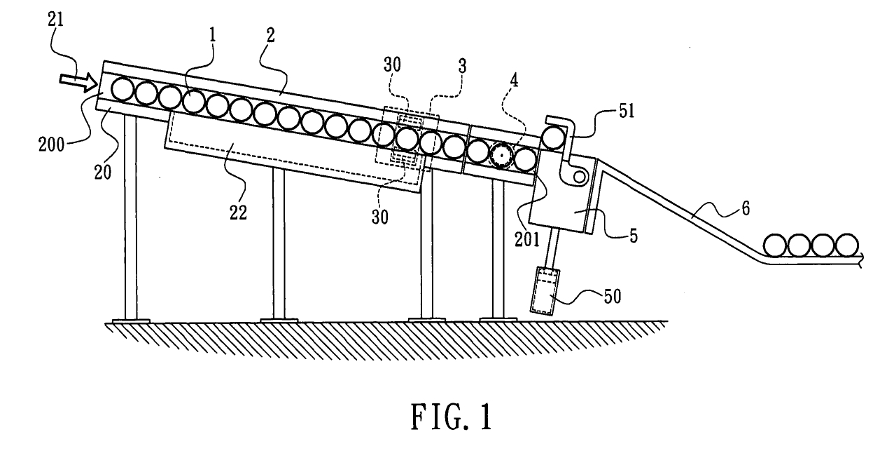

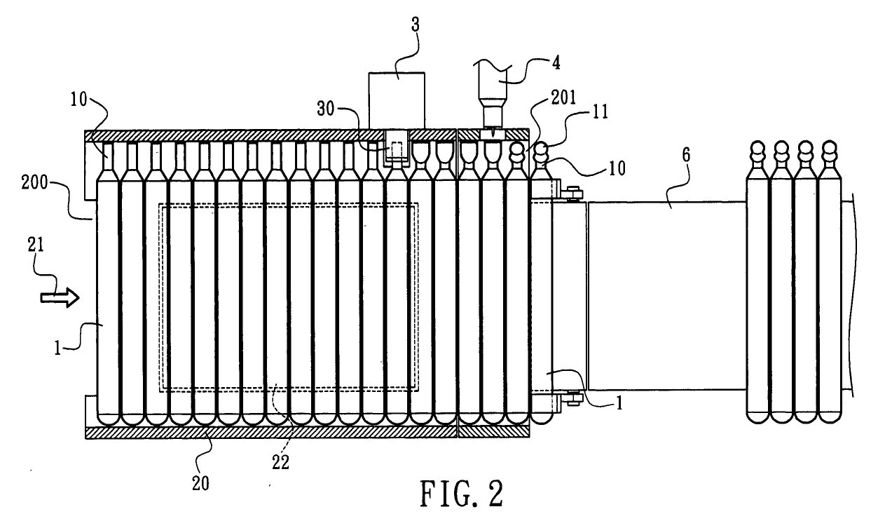

Referring to FIGS. 1 and 2, an apparatus for providing continuous and parallel conveyance of heat pipes comprises a feeding mechanism 2, a pressing mechanism 3 and a soldering mechanism 4.

The feeding mechanism 2 includes a process platform 20 which has a feeding end 200 and a dispense end 201. When the pipes 1 are disposed to lie on the process platform 20 in parallel, the level of the feeding end 200 can be higher than the level of the dispense end 201. Thereby, the process platform 20 is inclined downward from the feeding end 200 to the dispense end 201. Thereby, the pipes 1 can move along the feeding direction continuously. When the subsequent pipes 1 are fed in the feeding mechanism 2, the previously fed pipes 1 are pushed forward along the feeding direction 21.

Along the feeding direction 21, a heating element 22, the pressing mechanism 3 and the soldering mechanism 4 are installed on the process platform 20. The heating element 22 is used to input thermal energy to each pipe 1, such that the gas contained in the working fluid filled in the pipe 1 is removed due to temperature rise. Thereby, the gas removal process is complete at the time the pipes 1 are pushed towards the pressing mechanism 3.

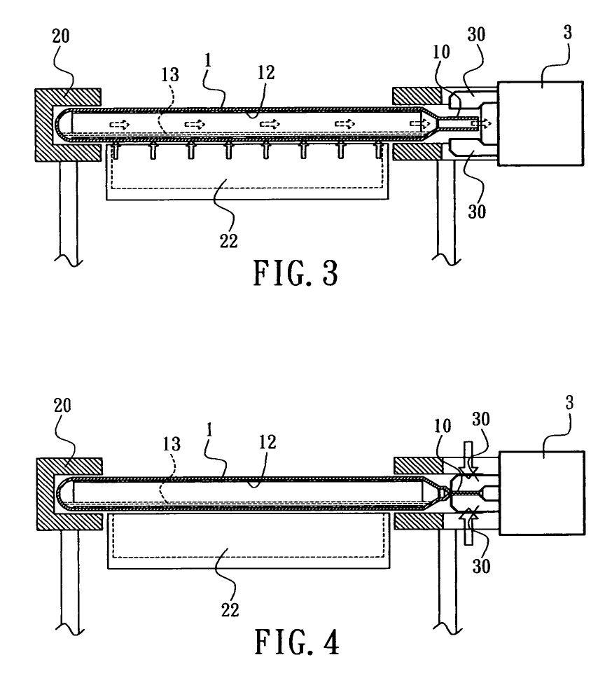

Referring to FIGS. 3 and 4, when after the gas removal process, the sealing ends 10 of the pipes 1 are press sealed that protrudes into the process platform 20 at one side where the sealing ends of the pipes 1 pointing at. As shown, the pressing mechanism 3 includes a pair of lower and upper molds 30 operative to move to each other, so as to press sealing the sealing end of the heat pipe 1 aligned therewith. Thereby, the sealing ends of the heat pipes 1 can be sealed after the uncondensed gas contained therein is removed. The pressing process can be performed at a high temperature to provide a thermal press. Thereby, the sealing effect can be enhanced.

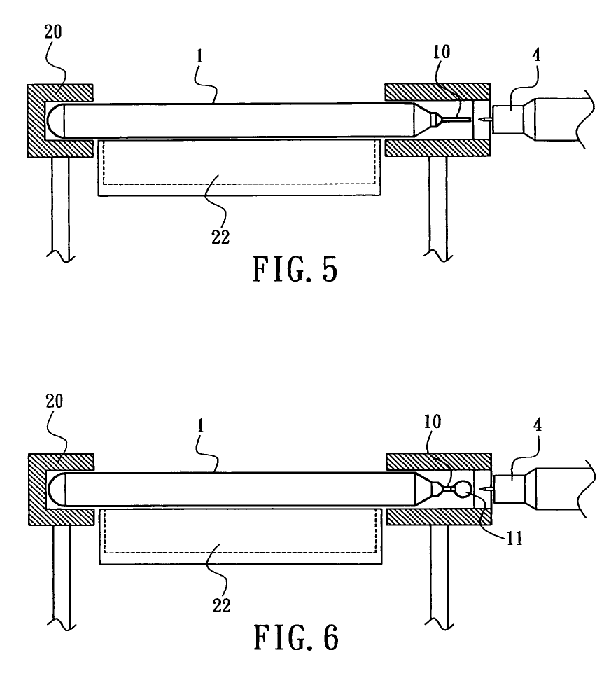

Referring FIGS. 5 and 6, after the traveling through the pressing mechanism 3, the pipes 1 are pushed towards the soldering mechanism 4, which includes a soldering point protruding into the process platform 20. When the sealed sealing ends of the heat pipes 10 are aligned with the soldering point, the sealing ends are solder to form soldering structures 11. Thereby, the gas removal and sealing processes are complete.

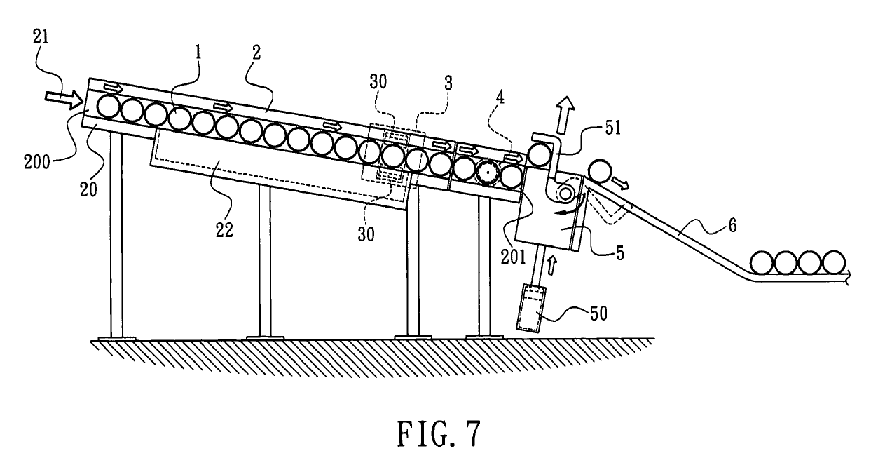

The apparatus may further comprises a dispense mechanism 5 located at the dispense end 201. The dispense mechanism 5 includes a sorting member 51 which sorts the pipes by a pressure chamber 50. Referring to FIG. 7, when the pipes 1 are under various types of processes, the dispense mechanism 5 uses the sorting member 51 to block the dispense end 201 of the process platform 20, so that the pipes 5 will only be sorted and dispensed after the above processes have been performed thereon. When all the above processes have been performed, the sorting member 51 dispense the processed pipes 1 out of the process platform 20, allowing more pipes 1 to be fed in the process platform 20 from the feeding end 200. The dispensed pipes 1 can be conveyed to a storage place by a carrying boar 6 for performing inspection or other related heat pipe process.

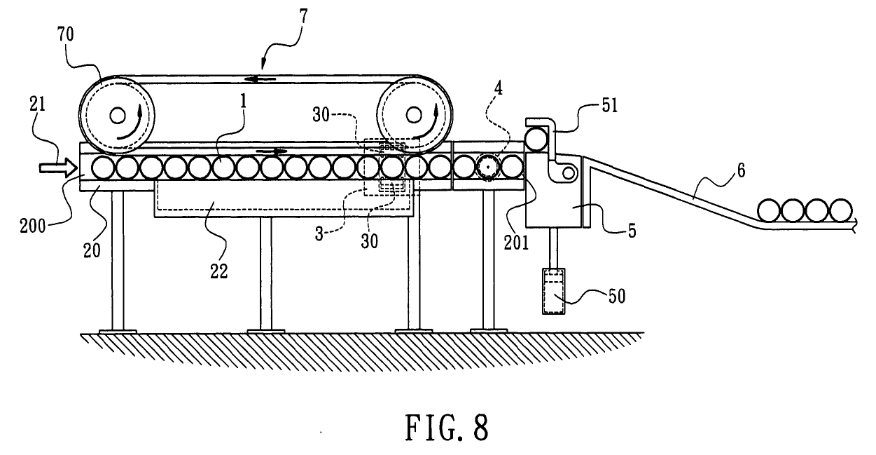

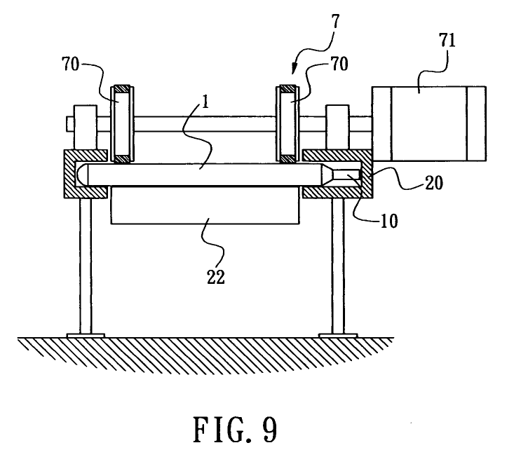

As shown in FIGS. 8 and 9, instead of the inclined arrangement, the process platform 20 of the feeding mechanism 2 can be disposed horizontally, and a pushing mechanism 7 can be installed therein. The pushing mechanism 7 includes at least a set of pulleys 70 and a motor 70 for driving the pulleys 70. In this embodiment, two pulleys 70 are pressed contact with two sides of the pipes 1 (as shown in FIG. 9) to convey the pipes 1 from the feeding end 200 to the dispense end 201.

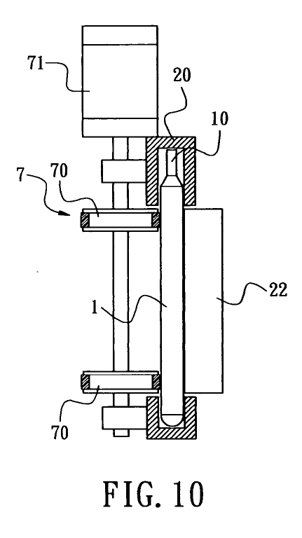

As shown in FIG. 10, when the apparatus is installed with the pushing mechanism 7, the process platform 20 can be disposed vertically or slanted to perform the processes.

By the apparatus as disclosed above, a method of continuously conveying heat pipes arranged parallel to each other is also provided. The method includes the following processes.

Firstly, the heat pipes 1 that contain the wick structure 12 and the working fluid 13 (as shown in FIG. 3) are abutting and arranged in parallel with each other. The pipes 1 are fed in the process platform 20 from the feeding end 200 and pushed towards the dispense end 201 by gravitation or by a set of pulleys, depending on the orientation of the process platform 20.

When the pipes 1 are moving along the process platform 20, thermal energy is input to the pipes 1 for removing the non-condensed gas therein.

After the gas has been removed from the pipes 1, the sealing ends of the pipes 1 are pressed by the pressing mechanism 2 protruding into the process platform 20.

After the pressing process, a soldering point protruding into the process platform 20 is used to solder the pressed sealing ends of the pipes.

The heat pipes 1 are then dispensed from the process platform 20 after the soldering process is performed thereon.

By the conveying apparatus and method disclosed above, the mechanical arm is not required for holding and transporting the heat pipes from one process station to the other. Therefore, no direct external force will be applied to the pipes 1, and the damage caused by such force is prevented. Meanwhile, as the pipes are abutting to each other, the feeding process of the subsequent pipes pushes the previously fed-in pipes to allow the processes continuously performed to the pipes.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. A method of continuously conveying and process heat pipes arranged in parallel to each other, comprising:
feeding a plurality of heat pipes each comprising a wick structure and a working fluid into a process platform;
inputting thermal energy to the heat pipes moving in the process platform;
pressing a sealing end of each heat pipe by protruding a pressing mechanism into the process platform; and
soldering the pressed sealing end of each heat pipe by protruding a soldering point into the process platform.

2. The method of claim 1, further comprising a step of slanting the process platform to push the heat pipes along a feeding direction by gravitation.

3. The method of claim 1, further comprising a step of installing a conveying mechanism at the process platform to push the heat pipes along a feeding direction.

4. The method of claim 3, further comprising a step of disposing the process platform horizontally.

5. The method of claim 1, further comprising a step of disposing the process vertically.

6. The method of claim 1, further comprising a step of conveying the heat pipes towards a slanted feeding direction.

7. The method of claim 1, further comprising a step of dispensing the heat pipes from the process platform.

8. An apparatus for continuously conveying heat pipes arranged parallel to each other, comprising:
a process platform having a feeding end and a dispensing end, wherein the heat pipes are fed into the process platform from the feeding end;
a heating element for heating the heat pipes fed in the process platform;
a pressing mechanism having an pair of pressing molds protruding into the process platform for pressing a sealing end of each of the heat pipes; and
a soldering mechanism having a soldering point protruding into the process platform for soldering the pressed sealing ends of the heat pipes.

9. The apparatus of claim 8, further comprising a push mechanism for pushing the heat pipes from the feeding end towards the dispense end.

10. The apparatus of claim 9, wherein the pushing mechanism includes a set of pulleys and a motor for driving the pulleys.

11. The apparatus of claim 8, wherein the process platform is slanted with the feeding end higher than the dispense end.

12. The apparatus of claim 8, wherein the pair of molds include an upper mode and a lower mold.
